(19) United States
(12) Patent Application Publication
(10) Pub. No.: US 2014/0292623 A1
(43) Pub. Date: Oct. 2, 2014

(54) ORGANIC LIGHT EMITTING DISPLAY DEVICE HAVING REPAIRED PIXEL AND PIXEL REPAIRING METHOD THEREOF

(71) Applicant: Samsung Display Co., Ltd., Yongin-city (KR)

(72) Inventors: Sung-Jae Moon, Yongin-city (KR); Kyong-Tae Park, Yongin-city (KR)

(73) Assignee: Samsung Display Co., Ltd., Yongin-city (KR)

(21) Appl. No.: 13/959,403

(22) Filed: Aug. 5, 2013

(30) Foreign Application Priority Data
Apr. 2, 2013 (KR) 10-2013-0035922

(51) Int. Cl. G09G 3/00; G09G 3/32

(52) U.S. Cl. CPC G09G 3/006; G09G 3/3216
USPC 345/82; 315/121; 29/825

(57) ABSTRACT

An organic light emitting display device employing organic light emitting diodes (OLEDs) is disclosed. One aspect includes a plurality of pixels positioned at intersection portions of scan lines and data lines, each having an organic light emitting diode and a pixel circuit driving the organic light emitting diode; a scan driver supplying a scan signal to the scan lines and supplying an emission control signal to an emission control line coupled to the pixels; and a data driver supplying a data signal to the data lines. In such organic light emitting display, the pixel circuit within each pixel includes three or more transistors and one or more capacitors, and the transistors included in a pixel circuit of some of the pixels is formed to be in a state in which the transistor is isolated from the other circuit devices in the pixel circuit or in a state in which the electrodes of the transistor are short-circuited.

### RELATED APPLICATIONS

This application claims priority to and the benefit of Korean Patent Application No. 10-2013-0035922, filed on Apr. 2, 2013, in the Korean Intellectual Property Office, the entire contents of which are incorporated herein by reference in their entirety.

### BACKGROUND

1. Field

The disclosed technology relates to an organic light emitting display device and a pixel repairing method thereof.

2. Description of the Related Technology

Various types of flat panel displays, capable of reducing the weight and volume of cathode ray tubes have been recently developed. Flat panel display technologies include liquid crystal display, field emission display, plasma display panel, organic light emitting diode (OLED) display, and the like.

An OLED type display forms images using organic light emitting diodes that emit light through recombination of electrons and holes. This display has a fast response speed and is driven with low power consumption.

### SUMMARY

According to one inventive aspect, an organic light emitting diode display includes a plurality of pixels; a scan driver; and a data driver. The plurality of the pixels are positioned at intersection portions of scan lines and data lines, each having an organic light emitting diode and a pixel circuit driving the organic light emitting diode. The scan driver supplies a scan signal to the scan lines and supplying an emission control signal to an emission control line coupled to the pixels. The data driver supplies a data signal to the data lines. Wherein the pixel circuit included in each pixel includes three or more transistors and one or more capacitors, and the one or more transistors included in a pixel circuit of some of the pixels is provided in a state in which the transistor is isolated from the other circuit devices in the pixel circuit or in a state in which source and drain electrodes of the transistor are short-circuited

The pixel circuit may include a first transistor coupled to corresponding scan and data lines, and transmitting, to the inside of the pixel, the data signal supplied from the data line when the scan signal is supplied from the scan line; a first capacitor storing a voltage corresponding to the data signal therein; and a second transistor coupled between a first power source and the organic light emitting diode, and supplying, to the organic light emitting diode, driving current corresponding to the voltage stored in the first capacitor. The pixel circuit may further include at least one of a third transistor coupled between the second transistor and the organic light emitting diode, and controlling the coupling between the second transistor and the organic light emitting diode, corresponding to the emission control signal supplied from the emission control line, and a fourth transistor coupled between the first power source and the second transistor, and controlling the coupling between the first power source and the second transistor, corresponding to the emission control signal supplied from the emission control line.

When one of the pixels has a transistor with a short between the source and drain (especially the third and fourth transistors), the gate electrode of the shorted transistor can be floated by isolating it from an input line.

The pixel circuit may further include a second capacitor coupled between one electrode of the first transistor and a constant voltage source, and storing the data signal transmitted from the first transistor; and a fifth transistor coupled between a first electrode of the second transistor and a coupling node between the first transistor and the second capacitor, and supplying, to the first electrode of the second transistor, a voltage stored in the second capacitor, corresponding to a first control signal supplied from a first control line coupled to a gate electrode of the fifth transistor.

The fifth transistor included in a pixel circuit of some of the pixels may be isolated from the first control line and provided in a state in which source and drain electrodes of the fifth transistor are short-circuited.

The second capacitor included in a pixel circuit of some of the pixels may be isolated from the other circuit devices in the pixel circuit.

The pixel circuit may further include a sixth transistor coupled between the first power source and the second transistor, and controlling the coupling between the first power source and the second transistor, corresponding to a second control signal supplied from a second control line; a seventh transistor coupled between an initialization power source and a first node to which one end of the first capacitor and a gate electrode of the second transistor are coupled, and transmitting the voltage of the initialization power source to the first node, corresponding to the second control signal; an eighth transistor coupled between the first node and a coupling node between the second and third transistors, and allowing the second transistor to be diode-coupled, corresponding to the first control signal; and a ninth transistor coupled between an anode electrode of the organic light emitting diode and the second control line or the initialization power source, and discharging a voltage stored in the organic light emitting diode, corresponding to the second control signal.

One or more of the sixth to ninth transistors included in a pixel circuit of some of the pixels may be provided in a state in which the transistors are isolated from the other circuit devices in the pixel circuit or the input signal line.

The organic light emitting display may further include a control driver supplying the first and second control signals to the respective first and second control lines. The control driver may supply, to the second control line, the second control signal that allows the sixth, seventh and ninth transistors to be turned on during a first period in a non-emission period in which the current path of driving current flowing from the first power source via the second transistor and the organic light emitting diode by the emission control signal supplied from the emission control line, and supply, to the first control line, the first control signal that allows the fifth and eighth transistors to be turned on during a second period subsequent to the first period in the non-emission period.

The organic light emitting display may further include a timing controller supplying a control signal to the scan driver and the data driver, and supplying, to the data driver, data supplied from the outside thereof. The timing controller may change data corresponding to the repaired pixel by applying a compensation value to the data, and output the changed data to the data driver.

According to another aspect of the disclosed technology, there is a pixel repairing method of an organic light emitting display may include: detecting a pixel in which a defect occurs among a plurality of pixels each having an organic light emitting diode, and a pixel circuit coupled to the organic light emitting diode and including three or more transistors and one or more capacitors; and isolating at least one transistor included in the defect pixel from the other circuit devices in the pixel circuit or allowing source and drain electrodes of the transistor to be short-circuited.

The pixel circuit included in each pixel may include four or more transistors and one or more capacitors. The pixel repairing method may include a first repairing process of isolating one or more transistors included in the defect pixel from the other circuit devices in the pixel circuit or allowing source and drain electrodes of the transistor to be short-circuited; a process of inspecting whether the defect pixel is operated; and a second repairing process of isolating another one or more transistors in the pixel from the other circuit devices in the pixel circuit or allowing source and drain electrodes of the transistor to be short-circuited, corresponding to the inspection result of the defect pixel.

The pixel repairing method may further include isolating a gate electrode of the transistor having the short-circuited source and drain electrodes from an input signal line.

The pixel circuit included in each pixel may include four or more transistors and two or more capacitors. The pixel repairing method may further include isolating at least one capacitor included in the defect pixel from the other circuit devices in the pixel circuit.

### BRIEF DESCRIPTION OF THE DRAWINGS

FIG. 1 is a block diagram illustrating an organic light emitting display according to one embodiment.

FIG. 2 is a circuit diagram illustrating one embodiment of a pixel shown in FIG. 1.

FIG. 3 is a waveform diagram illustrating a driving method of the pixel shown in FIG. 2.

FIG. 4 is a circuit diagram illustrating a method of repairing the pixel shown in FIG. 2 according to one embodiment.

FIG. 5 is a circuit diagram illustrating a method of repairing the pixel shown in FIG. 2 according to another embodiment.

FIG. 6 is a circuit diagram illustrating a method of repairing the pixel shown in FIG. 2 according to still another embodiment.

FIG. 7 is an equivalent circuit diagram the pixel repaired according to the embodiment shown in FIG. 6.

### DETAILED DESCRIPTION

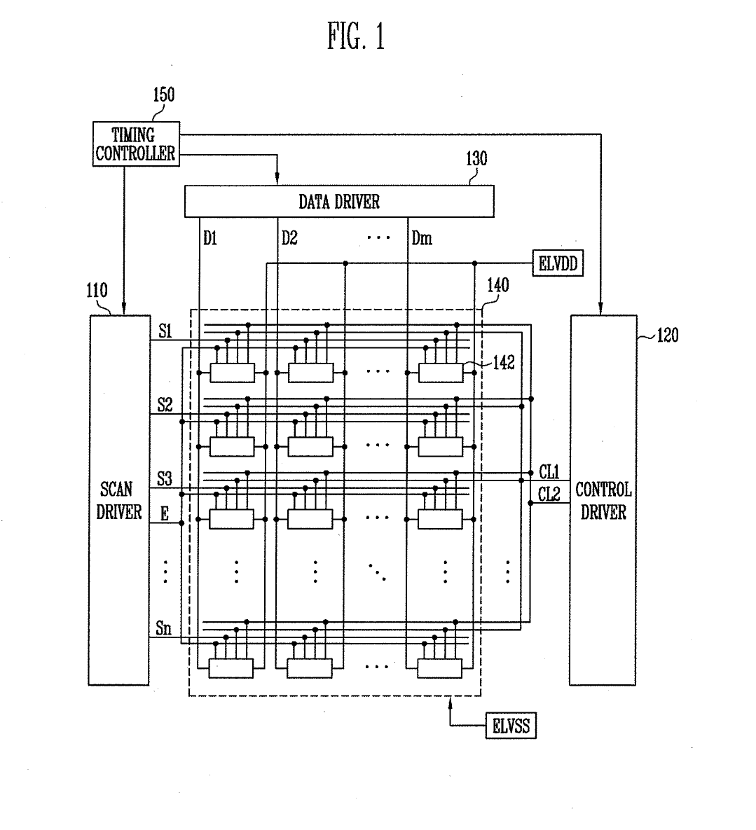

FIG. 1 is a block diagram illustrating an organic light emitting display according to one embodiment.

Referring to FIG. 1, the organic light emitting display includes a pixel unit 140 including a plurality of pixels 142 positioned at intersection portions of scan lines S1 to Sn and data lines D1 to Dm, a scan driver 110 for driving the scan lines S1 to Sn and an emission control line E, a control driver 120 for driving a first control line CL1 and a second control line CL2, a data driver 130 for driving the data lines D1 to Dm, and a timing controller 150 for controlling the scan driver 100, a control driver 120 and the data driver 130.

The organic light emitting display driven in such a manner that the pixels 142 are commonly coupled to the one emission control line E, the first control line CL1 and the second control line CL2 so as to emit light at the same time has been illustrated. That is, the configuration of the control lines E, CL 1 and CL2 coupled to the pixels 142 and the coupling between the control lines and the pixels 142 may be variously modified and embodied.

For convenience of illustration, it has been illustrated in FIG. 1 that the emission control line E is coupled to the scan driver 110 and the control lines CL1 and CL2 are coupled to the control driver 120. Practically, the emission control line E and the control lines CL1 and CL2 may be coupled to various drivers. For example, the emission control line E and the control lines CL1 and CL2 may be commonly coupled to the scan driver 110.

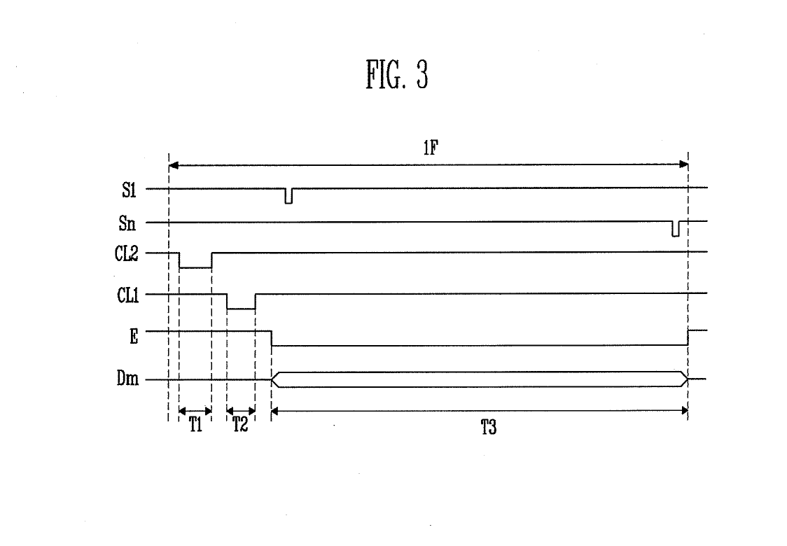

The scan driver 110 supplies a scan signal to the scan lines S1 to Sn. For example, the scan driver 110, as shown in FIG. 3, may progressively supply a scan signal to the scan lines S1 to Sn during a third period T3 of one frame 1F. Here, the scan signal supplied from the scan driver 110 is set to a voltage (e.g., a low voltage) at which transistors included in each pixel 142 are turned on. If the scan signal is progressively supplied to the scan lines S1 to Sn as described above, pixels 142 are progressively selected for each horizontal line, so that a data signal from the data lines D1 to Dm is input to the selected pixels 142 on the horizontal line.

The scan driver 110 also supplies an emission control signal to the emission control line E commonly coupled to the pixels 142. For example, the scan driver 110, as shown in FIG. 3, may supply an emission control signal to the emission control line E during the other periods T1 and T2 except the third period T3 of the one frame 1F. Here, the emission control signal supplied from the scan driver 110 is set to a voltage (e.g., a high voltage) at which the transistors included in each pixel 142 are turned off. If the emission control signal is supplied to the emission control line E as described above, the current path of driving current, formed in each pixel 142, is blocked, so that the pixel 142 does not emit light. That is, in FIG. 3, the first and second periods T1 and T2, in which the high-voltage emission control signal is supplied, are set as non-emission periods, and the third period T3, in which the supply of the emission control signal is stopped, is set as an emission period.

The control driver 120 supplies a first control signal to the first control line CL1 commonly coupled to the pixels 142, and supplies a second control signal to the second control line CL2 commonly coupled to the pixels 142. Here, the first and second control signals CL 1 and CL2 are supplied not to overlap each other during the other periods except the third period T3.

For example, the control driver 120, as shown in FIG. 3, may supply the second control signal to the second control line CL2 during the first period T1 in the non-emission period of the one frame 1F, and may supply the first control signal to the first control line CL1 during the second period T2 subsequent to the first period T1. Here, the first and second control signals are set to the voltage (e.g., the low voltage) at which the transistors are turned on.

The data driver 130 supplies a data signal to the data lines D1 to Dm so as to be synchronized with the scan signal supplied to the scan lines S1 to Sn during the third period T3 shown in FIG. 3. Meanwhile, in the organic light emitting display, the data driver 130 when in a three dimensional mode can alternately supply left and right data signals for each frame period.

The timing controller 150 controls the scan driver 110, the control driver 120 and the data driver 130, corresponding to a synchronization signal supplied from the outside of the organic light emitting display. To this end, the timing controller 150 supplies, to the scan driver 110, the control driver 120 and the data driver 130, a control signal for controlling operations of the scan driver 110, the control driver 120 and the data driver 130. The timing controller 150 also supplies, to the data driver 130, data supplied from the outside of the organic light emitting display.

The pixel unit 140 includes pixels 142 positioned at intersection portions of the scan lines S1 to Sn and the data lines D1 to Dm. The pixel unit 140 is driven, corresponding to first and second power sources ELVDD and ELVSS supplied from an external power circuit (not shown), etc., and scan and data signals respectively supplied from the scan and data drivers 110 and 130. The pixel unit 140 may be driven by further receiving an emission control signal from the scan driver 110 and control signals from the control driver 120 according to the structure of the pixels 142.

Each pixel 142 includes an organic light emitting diode and a pixel circuit for driving the organic light emitting diode, and expresses a gray scale while generating light with luminance corresponding to the data signal during the third period T3 shown in FIG. 3. To this end, each pixel 142 has a pixel circuit for controlling the amount of current flowing from the first power source ELVDD to the second power source ELVSS via the organic light emitting diode (not shown).

The pixel circuit included in each pixel 142 is configured to include three or more transistors and one or more capacitors. The pixel circuit has a structure including a plurality of circuit devices. In this case, the pixel circuit may include a plurality of circuit devices such as a circuit device for compensating for the threshold voltage of a driving transistor and a circuit device for smoothly inputting the data signal through initialization, thereby displaying an image with uniform image quality.

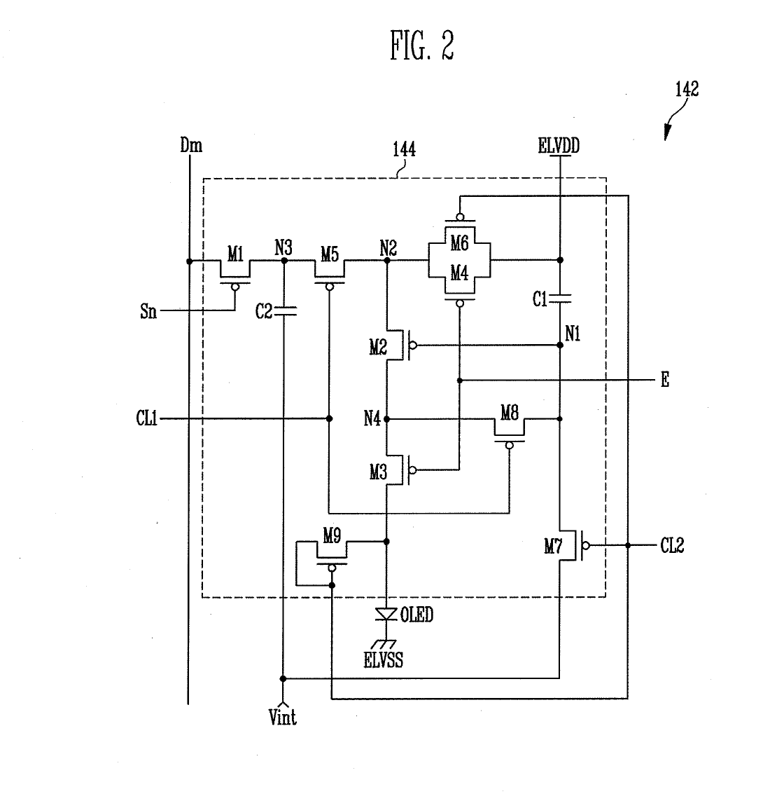

FIG. 2 is a circuit diagram illustrating an embodiment of the pixel shown in FIG. 1. For convenience for illustration, a pixel coupled to an n-th scan line Sn and an m-th data line Dm is shown in FIG. 2.

Referring to FIG. 2, the pixel 142 according to this embodiment includes an organic light emitting diode OLED and a pixel circuit 144 controlling driving current for driving the organic light emitting diode OLED.

An anode electrode of the organic light emitting diode OLED is coupled to the pixel circuit 144, and a cathode electrode of the organic light emitting diode OLED is coupled to the second power source ELVSS. The organic light emitting diode OLED generates light with luminance corresponding to the amount of driving current supplied from the pixel circuit 144. Meanwhile, the second power source ELVSS is set as a power source having a voltage lower than that of the first power source ELVDD so that the driving current can flow through the organic light emitting diode OLED.

The pixel circuit 144 controls the amount of driving current supplied to the organic light emitting diode OLED, corresponding to the data signal. To this end, the pixel circuit 144 includes first to ninth transistors M1 to M9 and first and second capacitors C1 and C2.

A first electrode of the first transistor M1 is coupled to the data line Dm, and a second electrode of the first transistor M1 is coupled to a third node N3. A gate electrode of the first transistor M1 is coupled to the scan line Sn. When a scan signal is supplied from the scan line Sn, the first transistor M1 is turned on to allow the data line Dm and the third node N3 to be electrically coupled to each other. That is, if the first transistor M1 is turned on by the scan signal, a data signal supplied from the data line Dm is transmitted to the inside of the pixel 142.

A first electrode of the second transistor (driving transistor) M2 is coupled to a second node N2, and a second electrode of the second transistor M2 is coupled to a fourth node N4. A gate electrode of the second transistor M2 is coupled to a first node N1. Here, the second node N2 is coupled to the first power source ELVDD via the fourth or sixth transistor M4 or M6, and the fourth node N4 is coupled to the organic light emitting diode OLED via the third transistor M3. That is, the second transistor M2 is coupled between the first power source ELVDD and the organic light emitting diode OLED.

The first power source ELVDD and the second node N2 are coupled to each other via the fourth transistor M4 and/or the sixth transistor M6, and the fourth node N4 and the organic light emitting diode OLED are coupled to each other via the third transistor M3, so that the second transistor M2 controls the driving current supplied to the organic light emitting diode OLED, corresponding to the voltage at the first node N1, during the emission period in which the current path of the driving current is formed. In this case, the voltage at the first node N1 is maintained, by the first capacitor C1, as a value corresponding to the voltage stored in the first capacitor C1.

A first electrode of the third transistor M3 is coupled to the fourth node N4, and a second electrode of the third transistor M3 is coupled to the anode electrode of the organic light emitting diode OLED. A gate electrode of the third transistor M3 is coupled to the emission control line E. The third transistor M3 is turned off when a high-voltage emission control signal is supplied to the emission control line E, and is turned on when the emission control signal is not supplied to the emission control line E. That is, the third transistor M3 is coupled between the second transistor M2 and the organic light emitting diode OLED, and controls the coupling between the second transistor M2 and the organic light emitting diode OLED, corresponding to the emission control signal supplied from the emission control line E.

A first electrode of the fourth transistor M4 is coupled to the first power source ELVDD, and a second electrode of the fourth transistor M4 is coupled to the second node N2. A gate electrode of the fourth transistor M4 is coupled to the emission control line E. The fourth transistor M4 is turned off when the high-voltage emission control signal is supplied to the emission control line E, and is turned on when the emission control signal is not supplied to the emission control line E. That is, the fourth transistor M4 is coupled between the first power source ELVDD and the second transistor M2, and controls the coupling between the first power source ELVDD and the second transistor M2, corresponding to the emission control signal supplied from the emission control line E.

A first electrode of the fifth transistor M5 is coupled to the third node N3 that is a coupling node of the first transistor M1 and the second capacitor C2, and a second electrode of the fifth transistor M5 is coupled to the second node N2 to which the first electrode of the second transistor M2 is coupled. A gate electrode of the fifth transistor M5 is coupled to the first control line CL1. When the first control signal is supplied from the first control line CL1, the fifth transistor M5 is turned on to allow the third and second nodes N3 and N2 to be electrically coupled to each other. If the third and second nodes N3 and N2 are electrically coupled to each other, the voltage stored in the second capacitor C2 is supplied to the first electrode of the second transistor M2. Meanwhile, when the fifth transistor M5 is turned on, the eighth transistor M8 is also turned on to allow the second transistor M2 to be diode-coupled. Accordingly, the voltage stored in the second capacitor C2 is transmitted to the first node N1.

A first electrode of the sixth transistor M6 is coupled to the first power source ELVDD, and a second electrode of the sixth transistor M6 is coupled to the second node N2. A gate electrode of the sixth transistor M6 is coupled to the second control line CL2. That is, the sixth transistor M6 is coupled between the first power source ELVDD and the second transistor M2, and controls the coupling between the first power source ELVDD and the second transistor M2, corresponding to the second control signal supplied from the second control line CL2.

A first electrode of the seventh transistor M7 is coupled to the first node N1, and a second electrode of the seventh transistor M7 is coupled to an initialization power source Vint. A gate electrode of the seventh transistor M7 is coupled to the second control line CL2. When the second control signal is supplied from the second control line CL2, the seventh transistor M7 is turned on to transmit the voltage of the initialization power source Vint to the first node N1.

A first electrode of the eighth transistor M8 is coupled to the fourth node N4 that is a coupling node of the second and third transistors M2 and M3, and a second node of the eighth transistor M8 is coupled to the first node N1. A gate electrode of the eighth transistor M8 is coupled to the first control line CL1. When the first control signal is supplied to the first control line CL1, the eighth transistor M8 is turned on to allow the second transistor M2 to be diode-coupled.

A first electrode of the ninth transistor M9 is coupled to the anode electrode of the organic light emitting diode OLED, and a second electrode of the ninth transistor M9 is coupled to the second control line CL2. A gate electrode of the ninth transistor M9 is coupled to the second control line CL1. That is, the ninth transistor M9 is diode-coupled between the anode electrode of the organic light emitting diode OLED and the second control line CL2. When the second control signal is supplied to the second control line CL2, the ninth transistor M9 transmits, to the anode electrode of the organic light emitting diode OLED, a voltage corresponding to the low voltage of the second control signal. Then, the voltage stored in parasitic capacitance structurally generated in the organic light emitting diode OLED is discharged.

Meanwhile, although it has been described in this embodiment that the voltage stored as the low voltage of the second control signal in the organic light emitting diode OLED is discharged. As another example, the voltage stored as the voltage of the initialization power source Vint in the organic light emitting diode OLED may be discharged. In this case, the second electrode of the ninth transistor M9 may be coupled to the initialization power source Vint.

The first capacitor C1 is coupled between the first power source ELVDD and the first node N 1. The first capacitor C1 charges a voltage corresponding to the data signal and the threshold voltage of the second transistor M2, corresponding to the voltage charged in the second capacitor C2.

The second capacitor C2 is coupled between the third node N3, to which the second electrode of the first transistor M2 is coupled, and a constant voltage source (e.g., the initialization power source Vint). When the first transistor M1 is turned on, the second capacitor C2 stores a voltage corresponding to the data signal transmitted from the first transistor M1.

Hereinafter, a driving method of the pixel according to this embodiment will be described in detail with reference to FIG. 3.

FIG. 3 is a waveform diagram illustrating a driving method of the pixel shown in FIG. 2.

Referring to FIG. 3, one frame period according to this embodiment is divided into a first period T1, a second period T2 and a third period T3. The first period T1 as an initialization period is a period in which a voltage for initializing the first node N1 and the anode electrode of the organic light emitting diode OLED is supplied. The second period T2 as a compensation period is a period in which a voltage corresponding to the data signal and the threshold voltage of the second transistor M2 is charged in the first capacitor C1. The third period T3 as a light emitting and data recording period is a period in which a voltage corresponding to the data signal is charged in the second capacitor C2, and simultaneously, the organic light emitting diode OLED generates light with a predetermined luminance.

First, a high-voltage emission control signal is supplied during the first and second periods T1 and T2, and the emission control signal is not supplied during the third period T3. If the emission control signal is supplied, the third and fourth transistors M3 and M4 are turned off. Accordingly, the current path of driving current is blocked during the first and second periods T1 and T2, so that the organic light emitting diode OLED is set to be in a non-emission state.

The second control signal is supplied to the second control line CL2 during the first period T1. If the second control signal is supplied to the second control line CL2, the sixth, seventh and ninth transistors M6, M7 and M9 are turned on.

If the sixth transistor M6 is turned on, the voltage of the first power source ELVDD is supplied to the second node N2.

If the seventh transistor M7 is turned on, the voltage of the initialization power source Vint is supplied to the first node N 1. Here, the voltage of the initialization power source Vint is set as a voltage lower than that of the data signal, and hence the second transistor M2 is set to be in an on-bias state during the first period T1.

If the ninth transistor M9 is turned on, a voltage corresponding to the low voltage of the second control signal is supplied to the anode electrode of the organic light emitting diode OLED. In this case, the ninth transistor M9 is diode-coupled, and therefore, a voltage is higher by the threshold voltage of the ninth transistor M9 than the low voltage of the second control signal is applied to the anode electrode of the organic light emitting diode OLED. Then, the voltage charged in a parasitic capacitor equivalently formed in the organic light emitting diode OLED is discharged by the low voltage of the second control signal, so that the anode electrode of the organic light emitting diode OLED is initialized. Meanwhile, in a case where the second electrode of the ninth transistor M9 is not coupled to the second control line CL2 but coupled to the initialization power source Vint, the anode electrode of the organic light emitting diode OLED is initialized by the voltage of the initialization power source Vint.

Subsequently, the first control signal is supplied to the first control line CL1 during the second period T2 subsequent to the first period T1. If the first control signal is supplied to the first control line CL1, the fifth and eighth transistors M5 and M8 are turned on.

If the fifth transistor M5 is turned on, the voltage of the data signal, stored in the second capacitor C2 in the previous period, is supplied to the second node N2. In this case, the voltage at the first node N1 has been initialized as the voltage of the initialization power source Vint, lower than that of the data signal, during the first period T1, and hence the second transistor M2 is turned on.

If the eighth transistor M8 is turned on, the second transistor M2 is diode-coupled.

Thus, the voltage corresponding to the data signal supplied to the second node N2 during the second period T2 is supplied to the first node via the diode-coupled second transistor M2. Then, a voltage corresponding to the data signal and the threshold voltage of the second transistor M2 is charged in the first capacitor C1.

The voltage at the second node N2 is expressed in Equation 1 by charge sharing of the first and second capacitors C1 and C2.

$$V ( N 2 ) = \frac{C 1 Vint + C 2 Vdata}{C 1 + C 2} \qquad Equation 1$$

In Equation 1, C1 denotes the capacity of the first capacitor, C2 denotes the capacity of the second capacitor, Vint denotes the voltage of the initialization power source, and Vdata denotes the voltage of the data signal.

Meanwhile, the voltage at the first node N1 turns on the diode-coupled second transistor M2. Therefore, the voltage at the first node N1 is set as a voltage lower by the threshold voltage of the second transistor M2 than that at the second node N2. This is expressed in Equation 2.

$$V ( N 1 ) = ( \frac{C 1 Vint + C 2 Vdata}{C 1 + C 2} ) - \vert Vth \vert \qquad Equation 2$$

In Equation 2, Vth denotes the threshold voltage of the second transistor M2.

That is, the second period T2 is a period for overcoming non-uniformity of image quality, caused due to the variation in the threshold voltage of the second transistor M2. The second period T2 is set as a compensation period in which a voltage corresponding to the data signal Vdata and the threshold voltage of the second transistor M2 is charged in the first capacitor C1.

Subsequently, as the emission period is started, the supply of the emission control signal to the emission control line E is stopped during the third period T3. Then, the third and fourth transistors M3 and M4 are turned on.

If the third transistor M3 is turned on, the second transistor M2 and the organic light emitting diode OLED are electrically coupled to each other. If the fourth transistor M4 is turned on, the first power source ELVDD is electrically coupled to the second transistor M2.

Accordingly, a current path of driving current flowing from the first power source ELVDD to the second power source ELVSS via the fourth transistor M4, the second transistor M2, the third transistor M3 and the organic light emitting diode OLED may be formed.

In this case, the second transistor M2 controls the amount of driving current, corresponding to the voltage applied to the first node N1, and the organic light emitting diode OLED generates light with luminance corresponding to the driving current.

The amount of driving current flowing through the organic light emitting diode OLED during the third period T3 is represented by the following Equation 3.

$$Ioled = \frac{1}{2} μ {C}_{ox} \frac{W}{L} {( ELVDD - V ( N 1 ) - \vert Vth \vert )}^{2} \\ Ioled = \frac{1}{2} μ {C}_{ox} \frac{W}{L} {( ELVDD - ( ( \frac{C 1 Vint + C 2 Vdata}{C 1 + C 2} ) - \vert Vth \vert ) - \vert Vth \vert )}^{2} \\ Ioled = \frac{1}{2} μ {C}_{ox} \frac{W}{L} {( ELVDD - \frac{C 1 Vint + C 2 Vdata}{C 1 + C 2} )}^{2} \qquad Equation 3$$

In Equation 3, p denotes the mobility of the second transistor M2, Cₒₓ denotes the gate capacitance of the second transistor M2, and W/L denotes the channel width/length ratio of the second transistor M2.

Referring to Equation 3, the driving current is generated regardless of the threshold voltage of the second transistor M2, and thus it is possible to compensate for the variation in the threshold voltage of the second transistor M2.

During the third period T3, a scan signal is progressively supplied to the scan lines S1 to Sn, and a data signal Vdata is supplied to the data lines D1 to Dm in synchronization with the scan signal.

Accordingly, as pixels 142 are progressively selected for each horizontal line, so that the data signal Vdata supplied from each of the data lines D1 to Dm is supplied to pixels 142 on a corresponding column through the first transistors M1 of the selected pixels 142.

Then, the data signal Vdata to be applied in the next emission period is charged in the second capacitor C2. Practically, the pixel 142 according to this embodiment implements a predetermined image while repeating the aforementioned process.

Meanwhile, the pixel of this embodiment described with reference to FIGS. 2 and 3 has a slightly complicated structure including the first transistor M1 for transmitting a data signal Vdata to the pixel, corresponding to the scan signal, the second transistor M2 for supplying, to the organic light emitting diode OLED, driving current corresponding to the data signal Vdata, and the first capacitor C1 for maintaining the voltage applied to the gate electrode of the second transistor during the supply of the driving current as a voltage corresponding to the data signal Vdata, and further comprising the third to ninth transistors M3 to M9 and the second capacitor C2 for controlling the emission period, which controls the emission period, performs initialization, compensates for the threshold voltage of the second transistor M2, and records the data signal during the emission period.

In this case, the features embodiments can be applied to all pixel structures further including other circuit devices for performing additional functions in addition to basic components of an AMOLED pixel, such as the first and second transistors M1 and M2 and the first capacitor C1. For example, the pixel applicable to the present embodiments may be a pixel further including the third transistor M3 and/or the fourth transistor M4 in addition to the first and second transistors M1 and M2 and the first capacitor C1.

The features of the present embodiments may be applied to all organic light emitting displays having a pixel configured to include three or more transistors M and one or more capacitors C. One inventive aspect is overcoming an increase in failure rate due to the additional circuit devices.

If the additional circuit devices are provided, the image quality may be improved by compensating for the threshold voltage of the driving transistor (i.e., the second transistor M2) or smoothly inputting the data signal Vdata through initialization.

However, in a case where a plurality of circuit devices are provided in the pixel circuit, it is highly likely that a defect will occur in the pixel circuit. Therefore, a pixel defect such as a bright spot failure or dark spot failure may occur. Particularly, the pixel defect such as the bright spot failure or dark spot failure is a defect which can be easily recognized by a user, which results in the lowering of a yield.

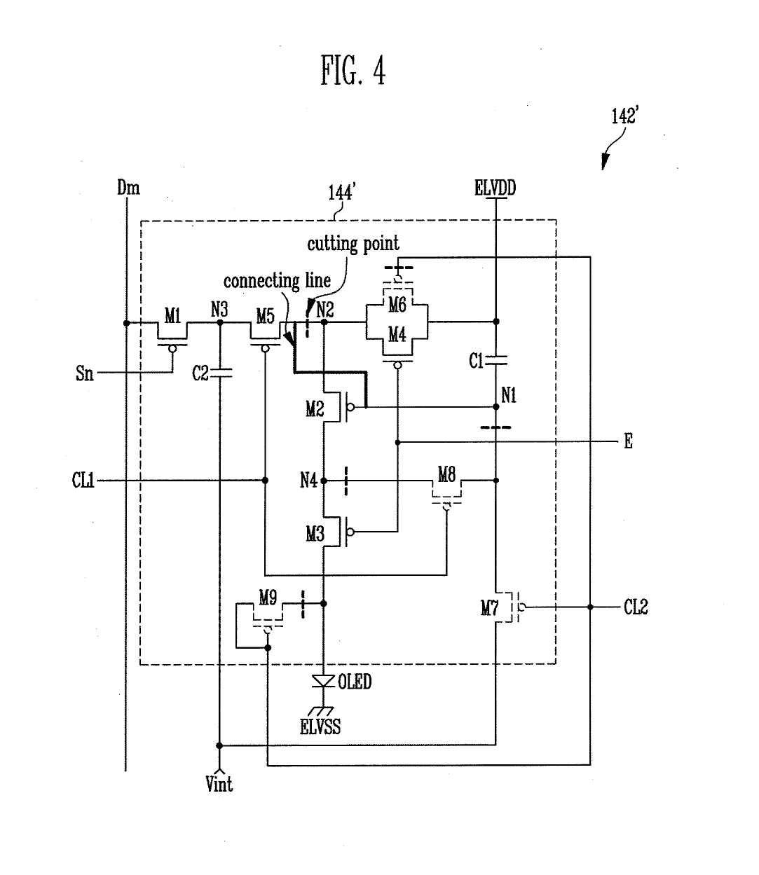

When a defect occurs in a pixel circuit, some circuit devices having defect factors are isolated from the other circuit devices or simply repaired as signal lines through which a signal and/or current can pass. Accordingly, it is possible to minimize influence which the defect of the pixel circuit has on the driving of a pixel and to improve the yield of the organic light emitting display. Hereinafter, various embodiments related to a pixel repairing method will be described with reference to FIGS. 4 to 7.

FIG. 4 is a circuit diagram illustrating a method of repairing the pixel shown in FIG. 2 according to one embodiment. For convenience of illustration, in FIG. 4, components identical or similar to those of FIG. 2 are designated by like reference numerals.

Meanwhile, when assuming that a pixel 142′ in which a defect occurs by performing a failure test in the manufacturing process of a product, the repair structure and repairing method of the defect pixel 142′ will be described in FIG. 4.

Referring to FIG. 4, in a case where a defect occurs in a pixel circuit 144′, some circuit devices having defect factors are isolated from the other circuit devices or simply repaired as signal lines through which a signal and/or current can pass, thereby minimizing influence which the defect of the pixel circuit 144′ has on the driving of the pixel 142′.

In repairing the defect pixel 142′, at least some of the other circuit devices except the first and second transistors M1 and M2 and the first capacitor C1 may be non-activated.

Thus, in a case where a defect occurs in the other circuit devices except the first and second transistors M1 and M2 and the first capacitor C1, the defect pixel 142′ may be normally repaired. However, it is relatively less likely that a defect may occur in the first and second transistors M1 and M2 among the first to ninth transistors M1 to M9. In addition, it is relatively less likely that a defect may occur in the first capacitor C1 when the capacitance of the second capacitor C2 is designed to be higher than that of the first capacitor C1. When considering these factors, it can be predicted that it is highly likely that the pixel 142′ may be normally operated through the repairing process described above.

Here, the normal operation of the pixel 142′ means that the pixel 142′ at lest emits light with luminance corresponding to the data signal Vdata. That is, although the variation in the threshold voltage of the second transistor M2, etc. is not compensated by loss of functions of some circuit devices, this will be a degree to which a user cannot recognize, as compared with a bright spot failure or dark spot failure, or the degree will be very insignificant. Particularly, when considering that the defect pixel 142′ occupies a very small portion of the entire pixel unit 140, it can be expected that the yield of the organic light emitting display will be improved through the repairing process described above.

In a case where the variation between the repaired pixel 142′ and the other pixels is serious, the position and compensation value of the repaired pixel 142′ are stored in the timing controller 150, etc., shown in FIG. 1, and data may then be changed so that the variation is compensated. In this case, the timing controller 150 may change data by applying the compensation value to the data corresponding to the repaired pixel 142′, and output the changed data to the data driver 130.

Meanwhile, it is considered that it is difficult to exactly measure a portion at which a defect occurs in the pixel 142′. In a case where the other circuit devices except the first and second transistors M1 and M2 and the first capacitor C1, i.e., the third to ninth transistors M3 to M9 and the second capacitor C2 are all non-activated, it is highly likely that the defect pixel 142′ may be repaired at a time, but only a portion of the other circuit devices may be non-activated in consideration of functions of the other circuit devices.

For example, as shown in FIG. 4, one or more of the sixth to ninth transistors M6 to M9 are non-activated, and it is then checked whether the pixel 142′ is normally operated. When the pixel 142′ is normally operated, the repairing of the pixel 142′ may be completed.

In a case where the sixth transistor M6 is non-activated, the gate electrode of the sixth transistor M6 may be isolated from the input signal line, i.e., the second control line CL2. This may be performed through a cutting (disconnecting) process of cutting (disconnecting) the coupling between the gate electrode of the sixth transistor M6 and the second control line CL2.

In a case where the seventh transistor M7 is non-activated, the coupling between the first node N1 and the seventh transistor M7 may be cut through the cutting process so that the seventh transistor M7 can be electrically isolated from the other circuit devices, e.g., the first to fifth transistors M1 to M5 and the first and second capacitors C1 and C2, which are normally coupled in the pixel circuit 144′.

In a case where the eighth transistor M8 is non-activated, both ends of the eighth transistor M8 may also be cut through the cutting process so that the eighth transistor M8 can be electrically isolated from the other circuit devices, e.g., the first to fifth transistors M1 to M5 and the first and second capacitors C1 and C2, which are normally coupled in the pixel circuit 144′.

In this case, the path along which a voltage corresponding to the data signal Vdata is stored in the first capacitor C1 is cut, and therefore, the connecting line through which the second electrode of the fifth transistor M5 is directly coupled to the first node N1 through the connecting process (shorting process) may be formed. Meanwhile, the coupling between the second electrode of the fifth transistor M5 and the second node N2 may be disconnected in order to cut the coupling between the first node N1 and the first power source ELVDD.

In a case where the ninth transistor M9 is non-activated, the ninth transistor M9 may be isolated from the other circuit devices by cutting the coupling between the ninth transistor M9 and the organic light emitting diode OLED through the cutting process.

That is, in this embodiment, when a defect occurs in one 142′ of the plurality of pixels 142 included in the pixel unit 140, one or more of the sixth to ninth transistors M6 to M9 included in the pixel circuit 144′ of the pixel 142′ is isolated from the other circuit devices in the pixel circuit 144′ or the input signal line, thereby repairing the pixel 142′.

Further, one or more of the sixth to ninth transistors M6 to M9 are non-activated, and it is then checked whether the pixel 142′ is normally operated. When the pixel 142′ is normally operated, the repairing of the pixel 142′ may be completed.

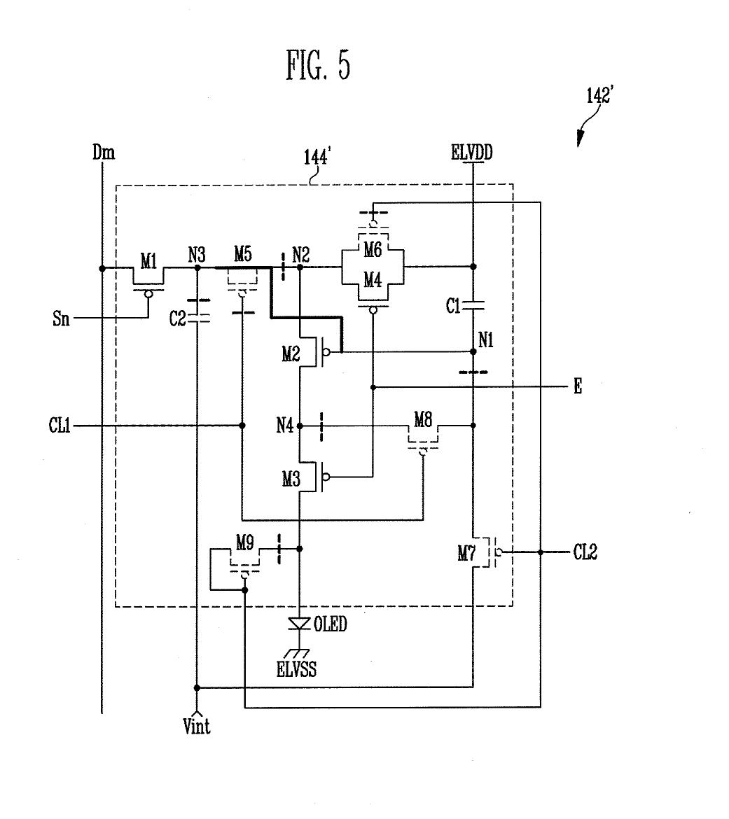

FIG. 5 is a circuit diagram illustrating a method of repairing the pixel shown in FIG. 2 according to another embodiment. In FIG. 5, portions identical or similar to those of FIG. 4 are designated by like reference numerals.

Referring to FIG. 5, the repairing process in which the fifth transistor M5 and the second capacitor C2 are non-activated may be performed.

In a case where the fifth transistor M5 is non-activated, the fifth transistor M5 may be simply repaired as a signal line through which the data signal Vdata can pass by allowing the first and second electrodes, i.e., the source and drain electrodes of the fifth transistor M5 to be short-circuited through the coupling process, and cutting the coupling between the gate electrode of the fifth transistor M5 and the first control line CL1 through the cutting process. That is, the gate electrode of the transistor (e.g., the fifth transistor M5) provided in the state in which the source and drain electrodes of the transistor are short-circuited may be floated by being isolated from the input signal line (e.g., the first control line CL1).

This is a repairing method performed by considering that in a case where the fifth transistor M5 is simply isolated from the other circuit devices, the data signal Vdata cannot be smoothly supplied to the first node N1. For example, the data signal Vdata may be supplied to the first node N1 by isolating the fifth transistor M5 from the other circuit devices and forming another connecting line.

In a case where the second capacitor C2 is non-activated, the coupling between the second capacitor C2 and the third node N3 may be cut through the cutting process, thereby isolating the second capacitor C2 from the other circuit devices in the pixel circuit 144′.

Thus, the pixel repaired according to the embodiment shown in FIG. 5 is provided in the state in which the fifth to ninth transistors M5 to M9 and the second capacitor C2, which are included in the pixel circuit 144′, are isolated from the other circuit devices in the pixel circuit 144′, particularly the first to fourth transistors M1 to M4 and the first capacitor C1, which are normally operated or in the state in which the source and drain electrodes of the fifth transistor M5 are short-circuited.

Meanwhile, the fifth and ninth transistors M5 to M9 and the second capacitor C2 are non-activated, and it is then checked whether the pixel 142′ is normally operated. When the pixel 142′ is normally operated, the repairing of the pixel 142′ may be completed.

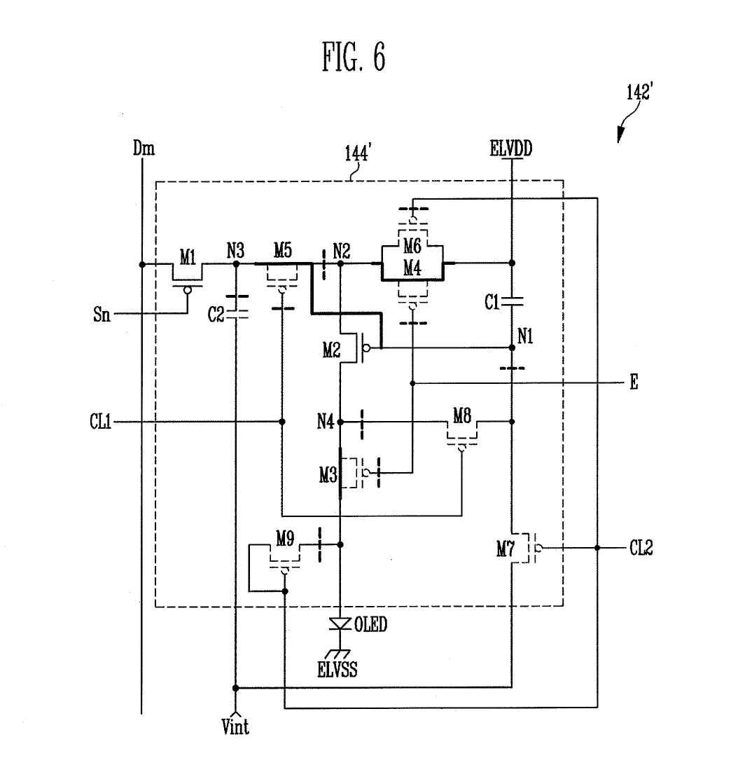

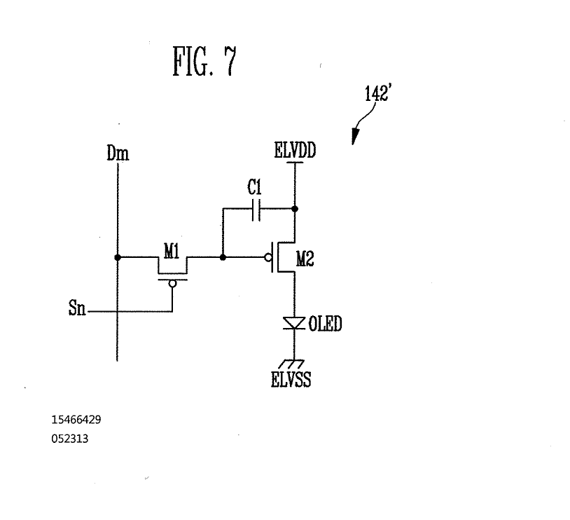

FIG. 6 is a circuit diagram illustrating a method of repairing the pixel shown in FIG. 2 according to still another embodiment. In FIG. 6, portions identical or similar to those of FIG. 4 are designated by like reference numerals. FIG. 7 is an equivalent circuit diagram of the pixel repaired according to the embodiment shown in FIG. 6.

First, referring to FIG. 6, the repairing process in which the third and fourth transistors M3 and M4 are non-activated may be performed.

In a case where the third transistor M3 is non-activated, the third transistor M3 may be simply repaired as a signal line through which the driving current can pass by allowing the first and second electrodes, i.e., the source and drain electrodes of the third transistor M3 to be short-circuited through the coupling process, and cutting the coupling between the gate electrode of the third transistor M3 and the emission control line E through the cutting process.

In a case where the fourth transistor M4 is non-activated, the fourth transistor M4 may be simply repaired as a signal line through which the driving current can pass by allowing the first and second electrodes, i.e., the source and drain electrodes of the fourth transistor M4 to be short-circuited through the coupling process, and cutting the coupling between the gate electrode of the fourth transistor M4 and the emission control line E through the cutting process.

In the pixel 142′ repaired as described above according to this embodiment, only the first and second transistors M1 and M2 and the first capacitor C1, will remain in the activated state. The equivalent circuit of the repaired pixel 142′ is shown in FIG. 7.

In this case, the pixel 142′ cannot compensate for the variation in the threshold voltage of the second transistor M2 by itself, but the repaired pixel 142′ can at least emit light with luminance corresponding to the data signal Vdata. Thus, although the variation in the threshold voltage of the second transistor M2, etc. is not compensated by loss of functions of some circuit devices, this will be a degree to which a user cannot recognize, as compared with a bright spot failure or dark spot failure, or the degree will be very insignificant. Particularly, when considering that the defect pixel 142′ occupies a very small portion of the entire pixel unit 140, it can be expected that the yield of the organic light emitting display will be improved through the repairing process described above.

In a case where the variation between the repaired pixel 142′ and the other pixels 142 is serious, this can be complemented by employing a method of changing data so that the variation is compensated in the timing controller 150, etc.

Meanwhile, in the pixel 142′ repaired as shown in FIGS. 6 and 7, it is highly likely that the pixel 142′ may be normally operated through the repairing process, as compared with the embodiment shown in FIGS. 4 and 5. Thus, the repairing process of the embodiment shown in FIG. 6 can be performed from the beginning in order to increase the probability that the pixel 142′ can be successfully repaired at a time.

However, in order to repair the defect pixel 142′ to have the structure of the other pixels 142 as similar as possible, only some of the third to ninth transistors M3 to M9 and the second capacitor C2 are first non-activated in consideration of their functions.

For example, if the pixel 142′ is not normally operated after being repaired according to the embodiment shown in FIG. 4, the pixel 142′ is repaired according to the embodiment shown in FIG. 5. Then, if the pixel 142′ is not normally operated, the pixel 142′ is repaired according to the embodiment shown in FIG. 6, thereby performing the repairing process in stages.

That is, the pixel repairing method of the organic light emitting display according to an embodiment may include detecting a pixel 142′ in which a defect occurs among a plurality of pixels 142 each including an organic light emitting diode OLED, and a pixel circuit 144 coupled to the organic light emitting diode OLED and having three or more transistors M and one or more capacitors C; and isolating at least one transistor M and/or capacitor C included in the defect pixel 142′ from the other circuit devices in a pixel circuit 144′ of the defect pixel 142′ or allowing source and drain electrodes of the transistor M to be short-circuited. Here, a gate electrode of the transistor M having the short-circuited source and drain electrodes may be isolated from an input signal line.

In this case, the detecting of the defect pixel 142′ may be performed, for example, in an array inspecting process, another inspecting process, etc.

The repairing method after the defect pixel 142 is detected may be performed in stages. For example, the repairing method may include a first repairing process of isolating one or more transistors M and/or one or more capacitors C, which included in the defect pixel 142′, from the other circuit devices in the pixel circuit 144′ or allowing the source and drain electrodes of the transistor M to be short-circuited; a process of inspecting whether the defect pixel 142′ is operated; and a second repairing process of isolating another one or more transistors M and/or another one or more capacitors C in the pixel 142′ from the other circuit devices in the pixel circuit 144′ or allowing the source and drain electrodes of the transistor M to be short-circuited, corresponding to the inspection result of the defect pixel 142′.

By way of summation and review, organic light emitting displays are generally classified into a passive-matrix type organic light emitting display (PMOLED) and an active-matrix type organic light emitting display (AMOLED) according to a method of driving an organic light emitting diode.

The AMOLED includes a plurality of scan lines, a plurality of data lines, and a plurality of pixels arranged in a matrix form by being connected to the scan lines and the data lines.

Each pixel includes an organic light emitting diode, and a pixel circuit for supplying, to the organic light emitting diode, driving current corresponding to a data signal.

Generally, the pixel circuit includes a driving transistor for controlling the driving current supplied to the organic light emitting diode, a switching transistor for transmitting the data signal to the driving transistor, and a storage capacitor for maintaining the voltage of the data signal. The pixel circuit may further include a transistor for compensating for the threshold voltage of the driving transistor and a transistor for transmitting an initialization voltage to the pixel circuit. That is, the pixel circuit may include a larger number of electronic devices.

AMOLED technology is widely used in various fields because of low power consumption.

However, in AMOLEDs, defects may occur in forming a pixel circuit including a plurality of transistors and capacitors, and therefore, the production yield of the organic light emitting displays is reduced.

In the organic light emitting display having the repaired pixel and the pixel repairing method thereof according to one embodiment, when a defect occurs in a pixel circuit, some circuit devices having the defect may be isolated from the other circuit devices, or a circuit device having the defect may be simply repaired as a signal line through which a signal or current can pass through a coupling process of coupling source and drain electrodes of the circuit device to each other.

Here, when a first element is described as being coupled to a second element, the first element may be not only directly coupled to the second element but may also be indirectly coupled to the second element via a third element. Also, like reference numerals refer to like elements throughout.

Accordingly, it is possible to minimize influence which the defect in the pixel circuit has on the driving of a pixel and to allow the pixel to emit light with luminance corresponding to a data signal, thereby improving the yield of the organic light emitting display.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. An organic light emitting display device, comprising:
a plurality of pixels at intersection portions of scan lines and data lines, each having an organic light emitting diode and a pixel circuit driving the organic light emitting diode;
a scan driver supplying a scan signal to the scan lines and supplying an emission control signal to an emission control line coupled to the pixels; and
a data driver supplying a data signal to the data lines,
wherein the pixel circuit included in each pixel comprises three or more transistors and one or more capacitors, and the one or more transistors included in a pixel circuit of some of the pixels is provided in a state in which the transistor is isolated from the other circuit devices in the pixel circuit or in a state in which source and drain electrodes of the transistor configured to be short-circuited without substantial degradation of a displayed image.

2. The organic light emitting display device of claim 1, wherein the pixel circuit further comprises:
a first transistor coupled to corresponding scan and data lines, and transmitting, to the inside of the pixel, the data signal supplied from the data line when the scan signal is supplied from the scan line;
a first capacitor storing a voltage corresponding to the data signal therein; and
a second transistor coupled between a first power source and the organic light emitting diode, and supplying, to the organic light emitting diode, driving current corresponding to the voltage stored in the first capacitor,
wherein the pixel circuit further includes at least one of a third transistor coupled between the second transistor and the organic light emitting diode, and controlling the coupling between the second transistor and the organic light emitting diode, corresponding to the emission control signal supplied from the emission control line, and a fourth transistor coupled between the first power source and the second transistor, and controlling the coupling between the first power source and the second transistor, corresponding to the emission control signal supplied from the emission control line.

3. The organic light emitting display device of claim 2, wherein at least one of the third and fourth transistors included in a pixel circuit of some of the pixels is provided in a state in which source and drain electrodes of the transistor are short-circuited.

4. The organic light emitting display device of claim 1, wherein a gate electrode of the transistor having the short-circuited source and drain electrodes is floated, being isolated from an input signal line.

5. The organic light emitting display device of claim 2, wherein the pixel circuit further comprises:
a second capacitor coupled between one electrode of the first transistor and a constant voltage source, and storing the data signal transmitted from the first transistor; and
a fifth transistor coupled between a first electrode of the second transistor and a coupling node between the first transistor and the second capacitor, and supplying, to the first electrode of the second transistor, a voltage stored in the second capacitor, corresponding to a first control signal supplied from a first control line coupled to a gate electrode of the fifth transistor.

6. The organic light emitting display device of claim 5, wherein the fifth transistor included in a pixel circuit of some of the pixels is isolated from the first control line and provided in a state in which source and drain electrodes of the fifth transistor are short-circuited.

7. The organic light emitting display device of claim 5, wherein the second capacitor included in a pixel circuit of some of the pixels is isolated from the other circuit devices in the pixel circuit.

8. The organic light emitting display device of claim 5, wherein the pixel circuit further comprises:
a sixth transistor coupled between the first power source and the second transistor, and controlling the coupling between the first power source and the second transistor, corresponding to a second control signal supplied from a second control line;
a seventh transistor coupled between an initialization power source and a first node to which one end of the first capacitor and a gate electrode of the second transistor are coupled, and transmitting the voltage of the initialization power source to the first node, corresponding to the second control signal;
an eighth transistor coupled between the first node and a coupling node between the second and third transistors, and allowing the second transistor to be diode-coupled, corresponding to the first control signal; and
a ninth transistor coupled between an anode electrode of the organic light emitting diode and the second control line or the initialization power source, and discharging a voltage stored in the organic light emitting diode, corresponding to the second control signal.

9. The organic light emitting display device of claim 8, wherein one or more of the sixth to ninth transistors included in a pixel circuit of some of the pixels are provided in a state in which the transistors are isolated from the other circuit devices in the pixel circuit or the input signal line.

10. The organic light emitting display device of claim 8, further comprising a control driver configured to supply the first and second control signals to the respective first and second control lines,
wherein the control driver supplies, to the second control line, the second control signal that allows the sixth, seventh and ninth transistors to be turned on during a first period in a non-emission period in which the current path of driving current flowing from the first power source via the second transistor and the organic light emitting diode by the emission control signal supplied from the emission control line, and supplies, to the first control line, the first control signal that allows the fifth and eighth transistors to be turned on during a second period subsequent to the first period in the non-emission period.

11. The organic light emitting display device of claim 1, further comprising a timing controller configured to supply a control signal to the scan driver and the data driver, and supplying, to the data driver, data supplied from the outside thereof,
wherein the timing controller changes data corresponding to the repaired pixel by applying a compensation value to the data, and outputs the changed data to the data driver.

12. A pixel repairing method of an organic light emitting display device, comprising:
detecting a pixel in which a defect occurs among a plurality of pixels each having an organic light emitting diode, and a pixel circuit coupled to the organic light emitting diode and including three or more transistors and one or more capacitors; and
isolating at least one transistor included in the defect pixel from the other circuit devices in the pixel circuit or allowing source and drain electrodes of the transistor to be short-circuited.

13. The pixel repairing method of claim 12, wherein the pixel circuit included in each pixel includes four or more transistors and one or more capacitors, and
wherein the pixel repairing method comprises:
a first repairing process of isolating one or more transistors included in the defect pixel from the other circuit devices in the pixel circuit or allowing source and drain electrodes of the transistor to be short-circuited;
a process of inspecting whether the defect pixel is operated; and
a second repairing process of isolating another one or more transistors in the pixel from the other circuit devices in the pixel circuit or allowing source and drain electrodes of the transistor to be short-circuited, corresponding to the inspection result of the defect pixel.

14. The pixel repairing method of claim 12, further comprising isolating a gate electrode of the transistor having the short-circuited source and drain electrodes from an input signal line.

15. The pixel repairing method of claim 12, wherein the pixel circuit included in each pixel includes four or more transistors and two or more capacitors, and
wherein the pixel repairing method further comprises isolating at least one capacitor included in the defect pixel from the other circuit devices in the pixel circuit.

16. A method of manufacturing an organic light emitting display device comprising:
forming a plurality of pixels at intersections of scan lines and data lines, each pixel having an light emitting portion and a pixel circuit driving the light emitting portion;
forming a scan driver to supply a scan signal to the scan lines and supplying an emission control signal to an emission control line;
forming a data driver to supply a data signal to the data lines
wherein the pixel circuit that is formed as a part of each pixel comprises three or more transistors and one or more capacitors;
wherein the circuit is designed to prevent substantial degradation of the image if one of the transistors is short circuited.

17. The method of claim 16 wherein each light emitting portion comprises an organic light emitting diode.

18. The method of claim 17 wherein the circuit is designed so that when a source and drain electrode are short-circuited the gate electrode is configured to be isolated from the input signal line.

19. The method of claim 17 wherein the pixel circuit further comprises four or more transistors and two or more capacitors.

20. The method of claim 19 wherein the second capacitor of the pixel circuit of some of the pixels is configured to be isolated from the other circuit devices in the pixel circuit.
